(19) United States
(12) Patent Application Publication
(10) Pub. No.: US 2011/0254199 A1
(43) Pub. Date: Oct. 20, 2011

(54) FAST CURABLE LIQUID RESIN PROCEDURE FOR THE MANUFACTURE OF MICRO/NANO FEATURED PARTS

(75) Inventors: Aaron D. Mazzeo, Cambridge, MA (US); Anthony J. Schrauth, Cambridge, MA (US); David E. Hardt, Concord, MA (US)

(73) Assignee: MASSACHUSETTS INSTITUTE OF TECHNOLOGY, Cambridge, MA (US)

(21) Appl. No.: 13/094,137

(22) Filed: Apr. 26, 2011

Related U.S. Application Data
(63) Continuation of application No. PCT/US2009/057257, filed on Sep. 17, 2009.
(60) Provisional application No. 61/110,176, filed on Oct. 31, 2008.

(51) Int. Cl. B28B 1/20

(52) U.S. Cl. 264/311

(57) ABSTRACT

A method of forming micro-based devices is provided that includes dispensing a liquid curable resin into a mold set with a reservoir section. Also, the method includes spinning the reservoir section and mold set so as to completely fill the patterning portion of the mold set with the liquid curable resin. The mold set is placed in a heating and cooling station that produces a cured part e. Also, the method includes moving the mold set and the cured part to a parting station, where the cured part is removed from the mold set.

### PRIORITY INFORMATION

This application claims priority from provisional application Ser. No. 61/110,176 filed Oct. 31, 2008, which is incorporated herein by reference in its entirety.

### BACKGROUND OF THE INVENTION

The invention is related to the field of mold casting, and in particular to a fast curable liquid resin used in the formation of micro/nano featured parts.

Products that have made use of centrifugal casting include: steel tubes, optical telecommunication fibers, polyester and polyvinyl pipes, functionally gradient metal-ceramic materials, porous ceramic supports for membrane applications, and gears. It has been demonstrated that casting large parts from thermoplastics can be accomplished. Rubber molds are used to produce metal alloy or plastic parts. Centrifugal casting of thermosets has also been demonstrated. There are two main purposes to centrifugal casting: mold filling and bubble removal. Centrifugal casting is commonly used in the art. However, the art of centrifugal casting has not focused on the manufacture of micro/nano featured parts.

### SUMMARY OF THE INVENTION

According to one aspect of the invention, there is provided a method of forming micro-based devices. The method includes dispensing a liquid curable resin into a mold set with a reservoir section. Also, the method includes spinning the reservoir section and mold set so as to completely fill the patterning portion of the mold set with the liquid curable resin. The mold set is placed in a heating station, which produces a cured part at a selective temperature. Moreover, the method includes moving the mold set and the cured part to a parting station, where the cured part is removed from the mold set.

According to another aspect of the invention, there is provided a method of forming micro devices using a mold set having micro-sized features. The method includes dispensing a liquid curable resin into the mold set with a reservoir section. Also, the method includes spinning the reservoir section and mold set so as to completely fill the patterning portion of the mold set with the liquid curable resin. The spinning removes bubbles and permits the simultaneous patterning of multiple sides of a part. The mold set is placed in a heating station, which heats and cools the mold set and resin. Moreover, the method includes moving the mold set and the cured part to a parting station, where the cured part is removed from the mold set.

### BRIEF DESCRIPTION OF THE DRAWINGS

FIG. 1 is a flowchart illustrating the inventive manufacturing process;

FIGS. 2A-2C are schematic diagram illustrating the use of a double mold set used in accordance with the invention;

FIGS. 3A-3C are schematic diagrams illustrating a polycarbonate mold set used in accordance with the invention; and

FIGS. 4A-4B are schematic diagrams illustrating an aluminum mold set used in accordance with the invention

FIGS. 5A-5D are images and graphs illustrating a bulk metallic glass channel and its corresponding PDMS replicate.

### DETAILED DESCRIPTION OF THE INVENTION

The invention describes a process for the manufacture of micro devices based on liquid resins. The specific material for which the process is designed is the liquid curable resin polydimethylsiloxane (PDMS), but this process should work with other resins like those aforementioned. The process should be capable of producing hundreds of quality, microfluidic parts in a cost effective, flexible, and fast manner. The invention also allows selective features to be formed having micro-sized structures dimensioned up to 1000 um and nano-sized structures having dimensions at least 1 nm in accordance with the invention.

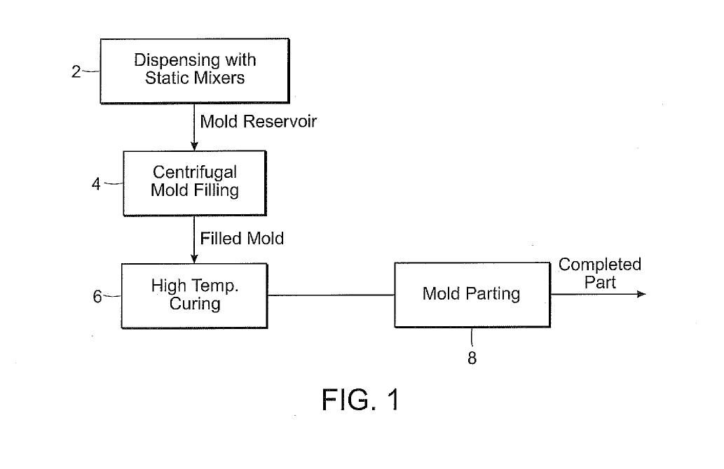

FIG. 1 illustrates an exemplary embodiment of the inventive manufacturing process, wherein the base and curing agent start in separate reservoirs. From the separate reservoirs, the base and curing agent then go through a static mixing nozzle, which splits and recombines laminar flows of the two reagents to adequately mix them without introducing bubbles, as shown in step 2. The material is then dispensed into a mold with a reservoir section. This reservoir section and mold are spun in a centrifuge, where a patterned section of the mold fills with PDMS, as shown in step 4. Any bubbles that would have been trapped in the patterning section escape and come toward the center of the centrifuge. After the double-sided mold has been adequately filled with the resin, it is placed in a heating station, which cures the material at an elevated temperature, as shown in step 6. In other embodiments, there can be mold sets having a single side or two or more sides. The part is then removed from the mold set using a molding parting station, as shown in step 8. The molding parting station can be done manually or automatically.

There are a number of advantages to the inventive manufacturing process in FIG. 1 as compared to typical prototyping methods. First, the processing times for degassing to remove bubbles and curing the polymer for the inventive process are on the order of minutes with potential for even shorter processing times, whereas typical prototyping processes take at least an hour. The fastest reported degassing and curing times for PDMS processing in the realm of micro/nano fabrication is 25 minutes.

Also, the liquid curable resin can be cured within the mold set placed in a heating and curing station. During the heating portion of the cycle, a heated portion of the station is actuated (moved) to make contact with the mold set. Upon making contact with the mold set, the primary heat transfer mechanism between the heated portion (heated source) of the station, the mold set, and the resin is conduction. When a desired period of time for heating has elapsed, the heated portion of the heating and curing station retracts. The cooling portion of the cycle is then initiated, whereby a cooled portion (heat sink) of the heating and curing station is actuated (move) to make contact with the mold set. Upon making contact with the mold set, the primary heat transfer mechanism between the cooled portion of the station, the mold set, and the resin is conduction. When a desired period of time for cooling has elapsed, the cooled portion of the heating and curing station retracts. The mold set is then removed from the heating and cooling station.

The centrifugal mold filling combined with the use of degassed materials from the reservoirs should eliminate the need for a time-consuming degassing step. Also, centrifugal molding makes it possible to mold two or more sides of a part; it is possible to place a featured mold on each side of the part being cured to form micro/nano features on two or more sides. The invention also allows micro/nano features to have micro-sized structures dimensioned up to 1000 um and nano-sized structures having dimensions at least 1 nm. In addition, this centrifugal molding technique with two mold halves will allow for better thickness control of the part than using a typical open-face casting method.

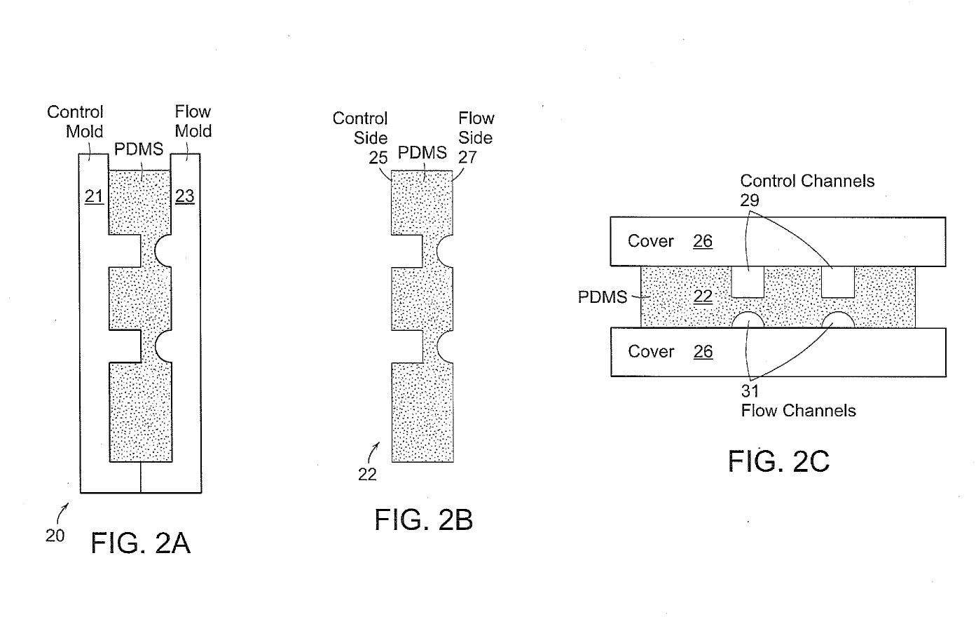

With respect to simultaneously molding two sides of a PDMS part, this capability might be particularly useful for manufacturing microfluidic devices with control and flow layers. PDMS layers with channels separated by a valve-acting membrane can be used to intelligently direct microfluidic flows. These control and flow layer PDMS systems are typically built by aligning and stacking multiple PDMS parts with channels only formed in one side of each part. Using the inventive molding process with molds similar to those shown in FIGS. 2A-2C, it should be possible to eliminate an alignment and bonding step of two separately molded PDMS parts. FIG. 2A shows how a single PDMS part 22 can be produced using a double-sided mold set 20 as shown in FIG. 2B where the double-sided mold set 20 includes a control mold 21 and flow mold 23 to produce the corresponding control side 25 and flow side 27. After the PDMS part 22 is removed from the mold 20, the part 24 could then be bonded to separate covers 26 without careful alignment procedures, as shown in FIG. 2C. Also shown in FIG. 2C are control channels 29 and flow channels 31 that are produced using the covers 26.

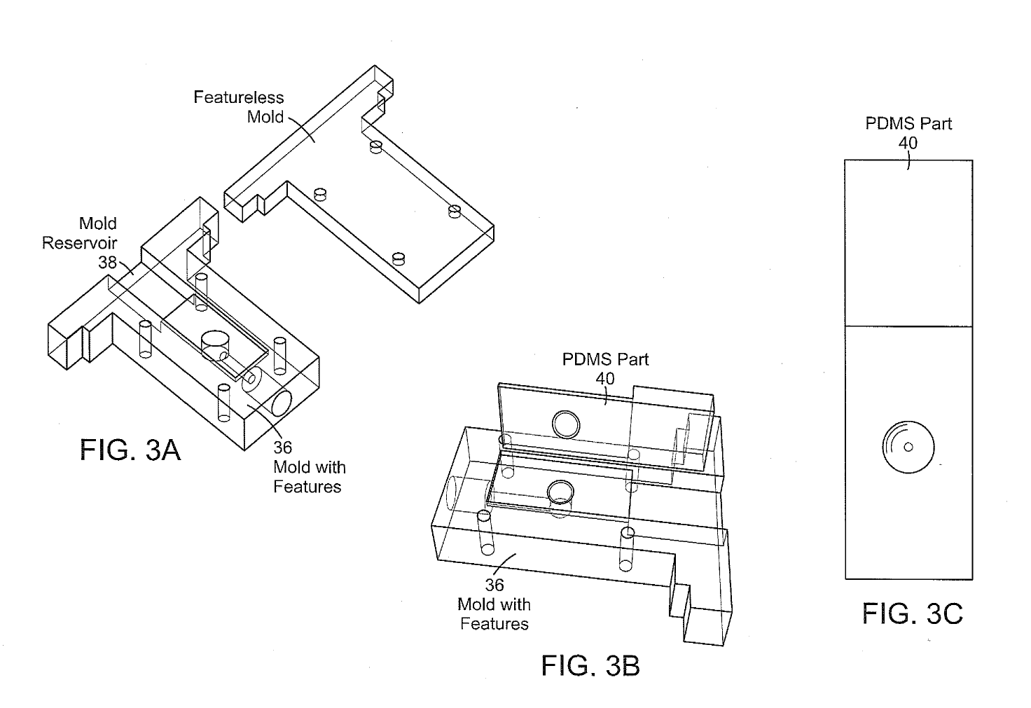

In an effort to demonstrate that the process in FIG. 1 works and can be scaled to larger quantities of parts, some initial experiments are performed using double-sided molds, a centrifuge, and a couple of heating methods. FIGS. 3A and 3B show images of a polycarbonate (PC) mold set 36 having a mold reservoir 38 used to mold a double-sided PDMS part 40. FIG. 3C shows the completed PDMS part. This part was produced by first assembling the PC mold set with bolts, washers, and nuts. Second, PDMS was dispensed into the mold reservoir section 38 of the mold set 36. Next, a Thinky mixer was used in its non-mixing mode to spin the mold set at approximately 2000 rpm with a maximum centrifugal acceleration of approximately 400 G for 180 seconds. The PDMS filled the rest of the molding volume and appeared bubble free. Finally, the mold set with uncured PDMS was suspended in boiling water (100° C.) for approximately 30 minutes. When the part 40 was removed, a few bubbles primarily near the edges where both sides of the mold set 36 made contact with each other were noticed and can be seen in FIG. 3C.

These initial results show that the relatively low centrifugal acceleration of 400 G was successful at filling the mold. In addition, this technique shows that many if not all bubbles can be removed using a centrifugal mold filling technique. Many of the bubbles appeared to result from trapped air in small crevices of the mold set. This air likely expanded when heated, and the air trapped in very small crevices may have formed micro bubbles that then coalesced to form bigger, visible bubbles. The uses of higher spinning speeds and/or longer spinning times result in bubble free parts.

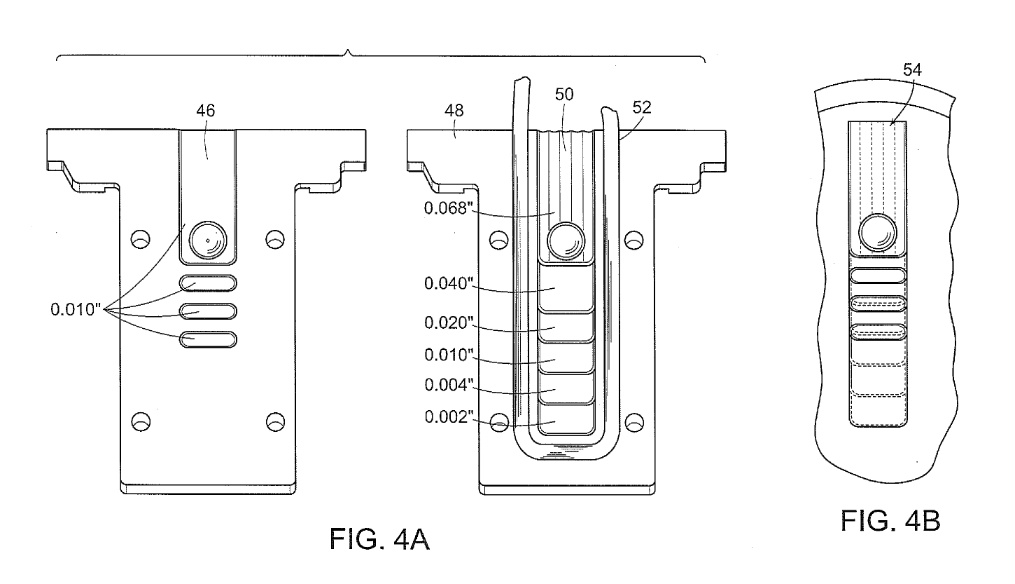

After performing the experiment shown in FIGS. 3A-3C another set of experiments was performed using an aluminum mold set. Using the aluminum mold set 44 having halves 46, 48 shown in FIG. 4A, PDMS was dispensed into the top section of the mold set after both halves 46, 48 were bolted together with a compressed Viton o-ring 52 sealing, as shown in FIG. 4A. Also, FIG. 4A shows the various measurements defining the mold set 44. The mold set 44 with the PDMS is then placed in the Thinky mixer with the same processing conditions used with the polycarbonate molds but for 240 seconds instead of 180 seconds. After which, the aluminum mold set 44 is clamped between two aluminum blocks sitting on a hot plate heated to approximately 200° C. After approximately 5 to 10 minutes of heating, the mold set 44 is removed and placed under running tap water to cool and quench the mold set 44. The mold set 44 is separated, and the cured PDMS part 54 is removed, as shown in FIG. 4B. In other embodiments, the mold sets can include others metals and Si.

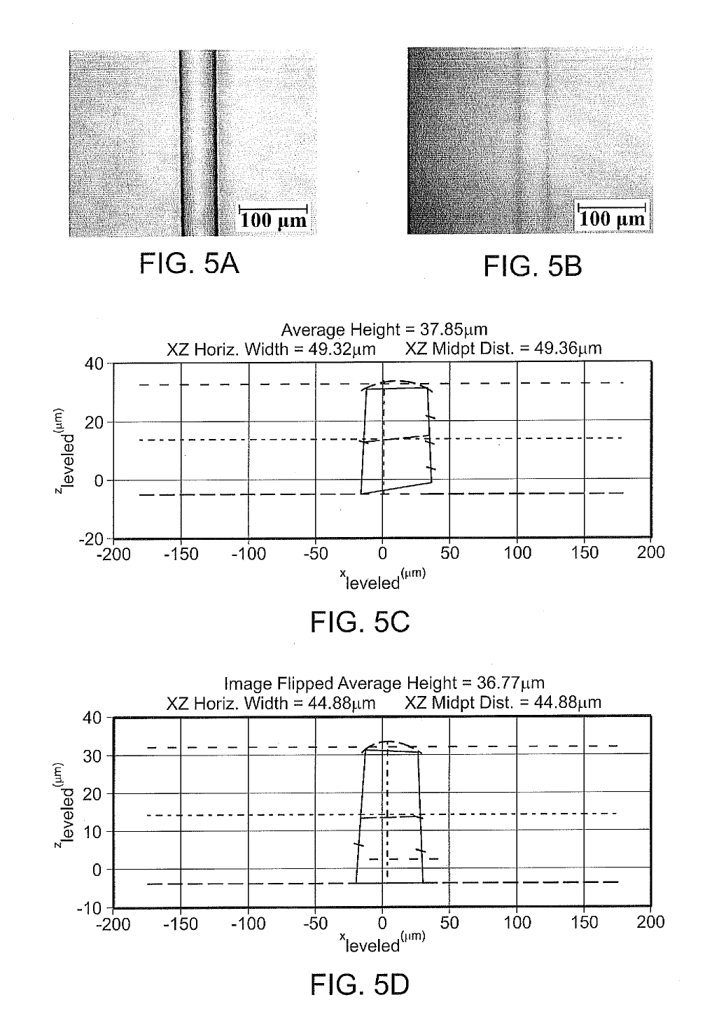

FIGS. 5A-5B shows images of a bulk metallic glass channel and its corresponding PDMS replicate. These channels are continuations of the bottom, vertical portions of a Y mixer. A Zygo profilometer was used to attain images of FIGS. 5A-5B and the plots shown in FIGS. 5C-5D are the results of post-processing the Zygo height measurements in MATLAB. The measured height for the hulk metallic glass channel is 37.9 μm, and the measured height of the PDMS channel is 36.8 μm. The measured width of the hulk metallic glass channel is 49.3 μm, and the measured width of the PDMS channel is 44.9 μm. These measurements are within a few microns of each other and differences in the measurements may be due to a variety of reasons: thermal contraction of the PDMS part lack of sidewall data in the Zygo measurements, feature deformation during demolding, etc.

These experimental results show that centrifugal molding combined with high temperature curing is a viable method for producing PDMS parts in a matter of minutes. There were a few bubbles present like those found in the PDMS part cured in boiling water (100° C.). However, larger centrifugal accelerations should lead to bubble free parts. In addition to curing PDMS in a double-sided mold at a high temperature, one can have poured liquid PDMS onto a hot plate at temperatures greater than 200° C. Within 30 seconds of pouring the PDMS onto a hot plate, the PDMS has cured enough so that it can be peeled off the hot plate. This hot plate experiment suggests that PDMS parts can be cured in less time than the 5 to 10 minutes used with the aluminum mold set, and that the quick curing property of PDMS should be conducive to manufacturing if the bubbles can be properly eliminated.

Although the present invention has been shown and described with respect to several preferred embodiments thereof, various changes, omissions and additions to the form and detail thereof, may be made therein, without departing from the spirit and scope of the invention.

What is claimed is:

1. A method of forming micro-based devices comprising:
dispensing a liquid curable resin into a mold set with a reservoir section;
spinning the reservoir section and mold set so as to completely fill the patterning portion of the mold set with the liquid curable resin;
placing said mold set in a heating station that produces a cured part; and
moving the mold set and the cured part to a parting station, where the cured part is removed from the mold set.

2. The method of claim 1, wherein said liquid curable resin comprises polydimethylsiloxane (PDMS).

3. The method of claim 1, wherein said mold set comprises a double sided mold set.

4. The method of claim 3, wherein said double sided mold set comprises metal or Si.

5. The method of claim 3, wherein said double sided mold set comprises polycarbonate or other plastic.

6. The method of claim 3, wherein said double sided mold set comprises a features mold to be placed on each side of said double sided mold set.

7. The method of claim 1, wherein said spinning of said reservoir section and mold set is accomplished using a centrifugal device.

8. The method of claim 1, wherein said spinning of said reservoir section and mold set removes air bubbles.

9. The method of claim 1, wherein said mold set comprises two or more sides.

10. The method of claim 1, wherein said mold set comprises one or more molded features producing features having dimensions of at least 1 nm.

11. A method of forming micro devices using a mold set having features comprising:
dispensing a liquid curable resin into said mold set with a reservoir section;
spinning the reservoir section and mold set so as to completely fill the patterning portion of the mold set with the liquid curable resin;
placing said mold set in a heating station that produces a cured part;
moving the mold set and the cured part to a parting station, where the cured part is removed from the mold set.

12. The method of claim 11, wherein said liquid curable resin comprises polydimethylsiloxane (PDMS).

13. The method of claim 11, wherein said mold set comprises a double sided mold set.

14. The method of claim 3, wherein said double sided mold set comprises metal or Si.

15. The method of claim 13, wherein said double sided mold set comprises polycarbonate or other plastic.

16. The method of claim 13, wherein said double sided mold set comprises a features mold to be placed on each side of said double sided mold set.

17. The method of claim 11, wherein said spinning of said reservoir section and mold set is accomplished using a centrifugal device.

18. The method of claim 11, wherein said spinning of said reservoir section and mold set removes air bubbles.

19. The method of claim 11, wherein said mold set comprises two or more sides.

20. The method of claim 11, wherein said mold set comprises one or more molded features producing said features having dimensions of at least 1 nm.
